(19) United States
(12) Patent Application Publication
(10) Pub. No.: US 2012/0039462 A1
(43) Pub. Date: Feb. 16, 2012

(54) RSA SIGNATURE METHOD AND APPARATUS

(75) Inventors: Doo Ho CHOI, Daejeon (KR); Yong-Je CHOI, Daejeon (KR)

(73) Assignee: Electronics and Telecommunications Research Institute, Daejeon (KR)

(21) Appl. No.: 13/196,214

(22) Filed: Aug. 2, 2011

(30) Foreign Application Priority Data
Aug. 12, 2010 (KR) 10-2010-0077811

(51) Int. Cl. H04L 9/28

(52) U.S. Cl. 380/28

(57) ABSTRACT

A Revest, Shamir and Adleman (RSA) signature method includes: creating an initial hidden value using a private key and an RSA modular; converting a message to a hidden message by blinding the message using the initial hidden value and the RSA modular; obtaining a result value by performing double exponentiation on the hidden message, the initial hidden value, the RSA modular and the private key; and recovering a signature value using the result value. The RSA signature method further includes updating the initial hidden value with a new hidden value after the recovering.

### CROSS-REFERENCE(S) TO RELATED APPLICATION

The present invention claims priority of Korean Patent Application No. 10-2010-0077811, filed on Aug. 12, 2010, which is incorporated herein by reference.

### FIELD OF THE INVENTION

The present invention relates to Rivest, Shamir and Adleman (RSA) signatures, and, more particularly, to an RSA signature method, and apparatus which are implemented to be secure from attacks using Simple Power Analysis (SPA), Differential Power Analysis (DPA) or the like.

### BACKGROUND OF THE INVENTION

The advent of the information society has increased the importance of protecting information using encryption algorithms and encryption protocols. Of these encryption algorithms, the RSA algorithm overcomes the key distribution problem and the digital signature problem, which are the problems of the Advanced Encryption Standard (AES) algorithm, and is being most widely used in various application fields, such as the Internet and financial networks. The RSA algorithm includes the traditional RSA algorithm and the RSA-Chinese Remainder Theorem (CRT) algorithm. In the present invention, these algorithms are collectively referred to as the “RSA algorithm.”

Meanwhile, the conventional RSA algorithm is vulnerable to side-channel attacks. For example, the RSA algorithm is vulnerable to power/electromagnetic wave analysis-based. side-channel attacks which collect information about, power consumption or electromagnetic waves occurring during the running of an encryption algorithm and analyze the secret information (chiefly, key information) of the encryption algorithm, using statistical analysis methods.

In particular, the conventional RSA algorithm has the problem of being vulnerable to SPA, which estimates a private key using power and the pattern of the waveform of electromagnetic waves leaking during one exponentiation operation, and DPA, which estimates a private key by collecting power and the pattern of the waveform of electromagnetic waves during repeated. operations and applying statistical processing to them.

### SUMMARY OF THE INVENTION

The present invention provides an RSA signature method and apparatus which are implemented to be secure from attacks using SPA or DPA.

In accordance with an aspect of the present invention, there is provided a Revest, Shamir and Adleman (RSA) signature method including: creating an initial hidden value using a private key and an RSA modular; converting a message to a hidden message by blinding the message using the initial hidden value and the RSA modular; obtaining a result value by performing double exponentiation on the hidden message, the initial hidden value, the RSA modular and the private key; and recovering a signature value using the result value,

In accordance with another aspect of present invention, there is provided an RSA signature apparatus including: a hidden value creating unit for creating an initial hidden value using a private key and an RSA modular; a message hiding unit for converting a message to a hidden message by blinding the message using the initial hidden value and the RSA modular; a double-exponentiation operation unit for obtaining a result value by performing double exponentiation on the hidden message, the initial hidden value, the RSA modular and the private key; and a signature value recovery unit for recovering a signature value using the result value.

### BRIEF DESCRIPTION OF THE DRAWINGS

The objects and features of the present invention will become apparent from the following description of preferred embodiments given in conjunction with the accompanying drawings, in which:

FIG. 1 is a block diagram of an RSA signature apparatus in accordance with an embodiment of the present invention; and

FIG. 2 is a flowchart of an RSA signature method in accordance with an embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function (s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with reference to the accompanying drawings which form a part hereof.

An RSA signature method and apparatus in accordance with the present invention can be applied to both, the traditional RSA algorithm and the RSA-CRT algorithm. As described above, in the present invention, these algorithms are collectively referred to as the “RSA algorithm.”

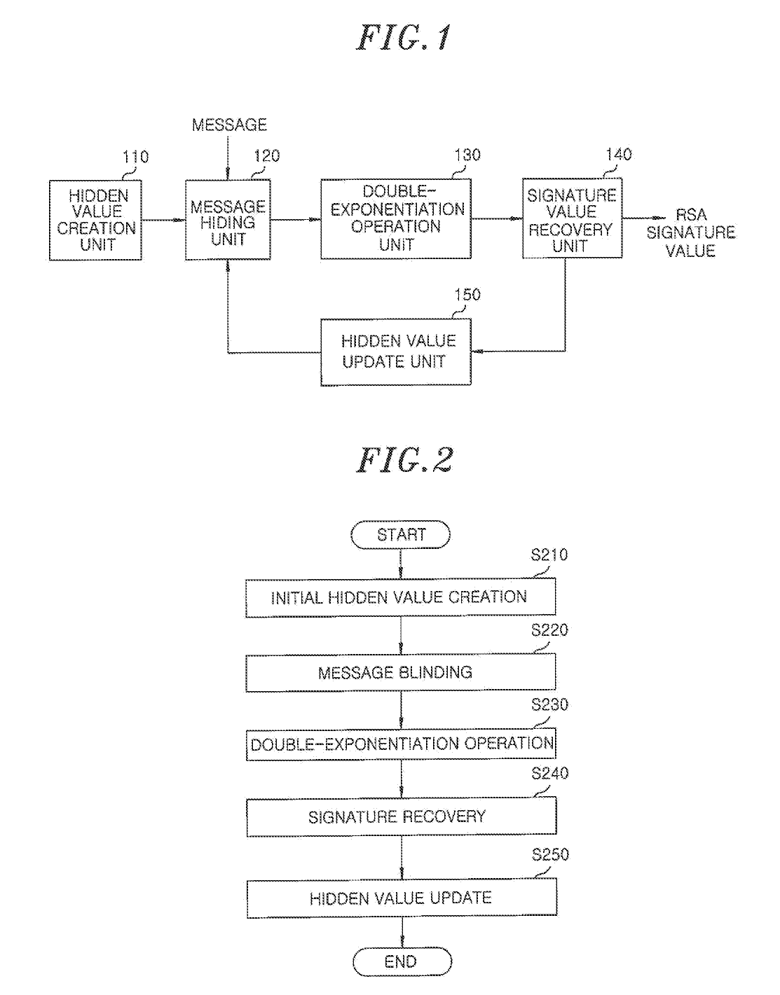

FIG. 1 is a block diagram of an RSA signature apparatus in accordance with an embodiment of the present invention.

As shown in FIG. 1, the RSA signature apparatus includes a hidden value creating unit 110, a message hiding unit 120, a double-exponentiation operation unit 130, a signature value recovery unit 140, and a hidden value update unit 150.

The hidden value creating unit 110 generates an initial hidden value using a private key and an RSA modular.

The message hiding unit 130 converts a message into a hidden message by blinding the message by using the initial hidden value, which has been generated by the hidden value creating unit 110, and the RSA modular.

The double-exponentiation operation unit 130 obtains a result value by performing double exponentiation on the hidden message, provided by the message hiding unit 130, the initial hidden value, the RSA modular, and the private key.

The signature value recovery unit 140 recovers the signature value by using the result value provided by the double-exponentiation operation unit 130.

The hidden value update unit 150 updates the initial hidden value with a new hidden value for the next use after the signature value recovery unit 140 has recovered the signature value.

FIG. 2 is a flowchart of an RSA signature method in accordance with an embodiment of the present invention.

As shown in FIG. 2, the RSA signature method includes step S210 of creating an initial hidden value using a private key and an RSA modular, step S220 of converting a message to a hidden message by blinding the message using the initial hidden value and the RSA modular, step S230 of obtaining a result value by performing double exponentiation on the hidden message, the initial hidden value, the RSA modular and the private key, step S240 of recovering a signature value using the result value, and step S250 of updating the initial hidden value with a new hidden value for the next use after the recovery step S240.

Referring to FIGS. 1 and 2, the RSA signature method using the RSA signature apparatus in accordance with the embodiment of the present invention will now be described in detail below.

Encryption, decryption, and the creation and verification of a digital signature in accordance with the RSA algorithm are performed using the following process.

A first user who desires cryptographic communication creates two large primes p and q, and calculates N=p*q. Thereafter, the first user selects the integer e which is relatively prime to phi(N)=(p−1)*(q−1), calculates d which satisfies ed=1 mod phi(N), publicly announces (N, e) as a public key, and then stores (p,q,d) as a private key.

A second user who desires to securely send a message M to the first user performs modular exponentiation, such as the following Equation 1, using the public key (N, e), and then sends the result value C to the first user.

C=M³ mod N Eq. 1

The first user who has received a result value C from

the second user recovers the original message M by performing modular exponentiation, such as the following Equation 2, using the first user's own private key d.

M=C^{d} mod N Eq. 2

The first user who desires to write a digital signature in the message M creates the digital signature S of the message M by performing modular exponentiation, such as the following Equation 3, using the first user's own private key d.

S=M^{d} mod N Eq. 3

The second user who has received the message M and the digital signature 5″ and desires to verify that the digital signature 5 is the signature of the message M created by the first user performs modular exponentiation, such as the following Equation 4, using the public key (N, e) of the first user, and may verify that the digital signature S is the signature of the message M created by the first user using the fact that a result value M′ obtained by performing the following Equation 4 should be the message M.

M′=S^{e} mod N Eq. 4

As described up to now, the RSA signature method in accordance with the present invention which can be applied to the RSA algorithm corresponds to the process of creating the digital signature S using Equation 3, which will be expressed by the following Equation 5:

Input: M in Z_{N}, N, and (vᵢ, v_{f}) Output: S=M^{d} mod N 1: M′←vᵢ·M mod N 2: (S′, v)←DualExpo (M′, v_{f}: N, d) 3: (Unblind) S∴v·S′ mod N 4: (Update) (vᵢ, v_{f})←(vᵢ², v_{f}²) mod N 5: return S Eq. 5

First, the hidden value creating unit 110 crates an initial hidden value using a private key d and an RSA modular N at step S210. For example, an initial hidden value (Vᵢ v_{f}) may be created by using a value d̅ with respect to which vector “1” is obtained when the logical sum of the value d̅ and the private key d is conducted. This is expressed by the following Equation 6:

[System Setup]1. Compute d̅ such that d⊕ d̅=1 2. Choose v′ᵢ at random 3. Compute vᵢ=v′^{d}^{ᵢ} mod N 4. Compute v′_{f}=(v′ᵢ)⁻¹ mod N 5. Compute v_{f}=(v′_{f})^{d} mod N 6. N,(vᵢ, v_{f}): input of RSA algorithm Eq. 6

Thereafter, the message hiding unit 130 converts the message M to a hidden message M′ by blinding the message M using an initial hidden value (vᵢ, v_{f}), created by the hidden value creating unit 110, and the RSA modular N at step S220. The reason for this is to prevent a DPA side-channel attack.

Thereafter, the double-exponentiation operation unit 130 calculates a result value by performing double exponentiation on the hidden message M′, provided by the message hiding unit 130, the initial hidden value (vᵢ, v_{f}), the RSA modular N and the private key d at step S230. This corresponds to the calculation of the DualExpo(-,-:-,-) function of Equation 5. For example, the left-to-right case is expressed by the following Equation 7.

Input: (M′, v_{f}) in Zₙ, d=[dₙ₋₁ . . . d₂d₁d₀]: binary representation Output: (S′=M′^{d} mod N, v=(v_{f}) ^{d̅} mod N) 1: Set S′←S′² mod N 4: v←v² mod N 5: if dₖ=1 then 6: S′←S′·M′ mod N 7: else 8: v←v·v_{f} mod N 9: end if 10: end or 11: return (S′, v) Eq. 7

As described above, in accordance with the double exponentiation procedure, two squaring operations and one multiplication operation are always repeated, so that it is difficult to estimate the private key d using SPA.

Thereafter, the signature value recovery unit 140 recovers a signature value by multiplying the elements of the result value pair (S′, v) of the double-exponentiation operation unit 130 together at step S240. This is expressed by the following Equation 8:

S=v·S′=(v_{f} ^{d̅}) (M′^{d}) mod N=(v_{f} ^{d̅}) (v_{f}^{d}) (M^{d}) mod N =(v′ᵢ^{dd})⁻¹(v′ᵢ^{dd})M^{d} mod N=M^{d} mod N Eq. 8

Finally, the hidden value update unit 150 updates the initial hidden value (vᵢ², v_{f}²) with a new hidden value for the next use after the signature value recovery unit 140 has recovered the signature value at step S250.

The present invention has the advantages of preventing DPA side-channel attacks by blinding messages and preventing the extraction of private keys based on SPA by using double exponentiation.

While the invention has been shown and described with respect to the preferred embodiments, it will be understood by those skilled in the art that various changes and modifications may be made without departing from the scope of the invention as defined in the following claims.

What is claimed is:

1. A Revest, Shamir and Adleman (RSA) signature method, comprising:
creating an initial hidden value by using a private key and an RSA modular;
converting a message to a hidden message by blinding the message by using the initial hidden value and the RSA modular;
obtaining a result value by performing double exponentiation on the hidden message, the initial hidden value, the RSA modular and the private key; and
recovering a signature value by using the result value.

2. The RSA signature method of claim 1, further comprising updating the initial hidden value with a new hidden value after the recovering.

3. The RSA signature method of claim 1, wherein said creating creates the initial hidden value using a value with which vector “1” is obtained by performing a logical sum of this value and the private key.

4. The RSA signature method of claim 1, wherein said obtaining includes repeating two squaring operations and one multiplication operation.

5. The RSA signature method of claim 1, wherein said recovering includes recovering the signature value by multiplying elements of a value pair of the result value together.

6. The RSA signature method of claim 2, wherein said creating creates the initial hidden value using a value with which vector “1” is obtained by performing a logical sum of this value and the private key.

7. The RSA signature method of claim 2, wherein said obtaining includes repeating two squaring operations and one multiplication operation.

8. The RSA signature method of claim 2, wherein said recovering includes recovering the signature value by multiplying elements of a value pair of the result value together.

9. An RSA signature apparatus, comprising:
a hidden value creating unit for creating an initial hidden value using a private key and an RSA modular;
a message hiding unit for converting a message to a hidden message by blinding the message using the initial hidden value and the RSA modular;
a double-exponentiation operation unit for obtaining a result value by performing double exponentiation on the hidden message, the initial hidden value, the RSA modular and the private key; and
a signature value recovery unit for recovering a signature value using the result value.

10. The RSA signature apparatus of claim 9, further comprising a hidden value update unit for updating the initial hidden value with a new hidden value after the signature value recovery unit has recovered the signature value.

11. The RSA signature apparatus of claim 9, wherein the hidden value creating unit creates the initial hidden value using a value with which vector “1” is obtained by performing a logical sum of this value and the private key.

12. The RSA signature apparatus of claim 9, wherein the double-exponentiation operation unit repeats two squaring operations and one multiplication operation.

13. The RSA signature apparatus of claim 9, wherein the hidden value update unit recovers the signature value by multiplying elements of a value pair of the result value together.

15. The RSA signature apparatus of claim 10, wherein the hidden value creating unit creates the initial hidden value using a value with respect to which vector “1” is obtained by performing a logical sum of this value and the private key.

16. The RSA signature apparatus of claim 10, wherein the double-exponentiation operation unit repeats two squaring operations and one multiplication operation.

17. The RSA signature apparatus of claim 10, wherein the hidden value update unit recovers the signature value by multiplying elements of a value pair of the result value together.
